(19) United States
(12) Patent Application Publication
(10) Pub. No.: US 2014/0135971 A1
(43) Pub. Date: May 15, 2014

(54) SEWING DESIGN MANUFACTURING MANAGEMENT APPARATUS AND METHOD

(71) Applicant: In Chul Park, Seodaemun-gun (KR)

(72) Inventor: In Chul Park, Seodaemun-gun (KR)

(73) Assignee: SUNSTAR CO., LTD., Incheon (KR)

(21) Appl. No.: 14/129,251

(22) PCT Filed: Jun. 29, 2012
(86) PCT No.: PCT/KR2012/005185

§ 371 Date: Dec. 24, 2013

(30) Foreign Application Priority Data
Jun. 30, 2011 (KR) 10-2011-0064846
Feb. 10, 2012 (KR) 10-2012-0013745

(51) Int. Cl. G06Q 50/04; A41H 42/00; D05B 19/12

(52) U.S. Cl. CPC G06Q 50/04; D05B 19/12; A41H 42/00
USPC 700/137; 700/136

(57) ABSTRACT

Provided are a sewing design manufacturing management apparatus and method, which can provide information associated with sewing processes necessary for manufacturing an end product, on the basis of sewing design information. In order for a user to easily input information and data necessary for a sewing process, a design shape for each process is provided by analyzing the sewing design information of an end product generated or provided from the outside. The design shape for each process makes it easier to input sewing information and sewing data on a corresponding process. Working hours and cost may be calculated on the basis of at least one of the input sewing information and sewing data. The sewing information and sewing data may be transmitted to a corresponding sewing manufacturing device over a network, thereby setting work parameters for performing a necessary process.

### TECHNICAL FIELD

The present disclosure relates to producing sewing designs, and more particularly, to a sewing design manufacturing management apparatus and method, which enable a user to easily setup and modify information regarding a sewing process.

### BACKGROUND ART

To date, in manufacturing an end product by sewing, a large company with capital and a distribution network develops an end product design to be manufactured by sewing, and asks a product manufacturer to manufacture the product based on the design and deliver the manufactured product to the large company. Given the above, the sewing industry suffers from difficulties in manufacturing the end products by sewing due to the fact that manufacturing productivity depends greatly on how well trained and cared for the skilled workers are. Also, under the above manufacturing structure, asking the product manufacturer in the form of a subcontract or outsourcing, both the large companies and the manufacturers have not been able to introduce new competitive technology or to manage end product designs in a systematic and integrated structure, and thus, the manufacturing efficiency of the end products by sewing has not been improved substantially in several decades.

As industrial technologies develop progressively, an advanced sewing manufacturing device may be configured to utilize a high-tech microprocessor in manufacturing the end products, but there are no apparatuses or methods allowing for exchanging and sharing data effectively so that end product design information is directly associated with a sewing manufacturing device.

### DISCLOSURE OF INVENTION

### Technical Problem

A design system for an end product to be manufactured by sewing has been widely known. As an example of the system, there is a clothing Computer Aided Design (CAD) system for designing a clothing design, which can only provide shape and coupling information of items that comprise an entire clothing product. Therefore, even though an end product manufacturer receives sewing design information that has been generated by the CAD system, the end product manufacturer needs to input separate sewing data necessary for an actual sewing process by himself. That is, first, the sewing design information generated by the CAD system is provided to a separate sewing data input device, and then, a user of the sewing data input device needs to indicate for every sewing portion, shape information displayed on the input device by using a pointing device such as a mouse, and input further necessary information with an input means such as a keyboard.

However, since the above-described conventional sewing data input device requires a user to designate a corresponding sewing portion and input necessary sewing data by himself, a significant amount of time is spent on inputting data. Moreover, the conventional sewing data input device is quite expensive and inefficient because the sewing data input device needs to be configured separately from the CAD system.

In addition, when a sewing design has been modified by the CAD system, the sewing data input device should prepare new sewing data based on the modified sewing design, irrespective of what sewing data is already inputted. Thus, it becomes a hassle for the user, and chances are increased that an error occurs in inputting sewing data.

As a result, the conventional sewing data input device requires specialized manpower (skilled workers) having specific knowledge to input sewing data, and the quality of products is substantially dependent on the level of skill that a worker may have for inputting the sewing data.

Moreover, when an actually manufactured end product does not fit with the CAD-prepared design, there have been many disputes regarding the responsibility for the design failures between the person placing the sewing order and the end product manufacturer.

In addition, when a problem occurs in a sewing manufacturing device during a sewing task, there are hardly any means to provide an efficient and fast solution to the problem in order to resume the sewing task.

As seen from the above description, the conventional technology cannot efficiently manage an entire process from making a sewing design to produce a product. Thus, the efficiency of manufacturing a product is reduced, calculating the cost is difficult, and the time of manufacturing the product is wasted. To solve such limitations, the present disclosure provides a sewing design manufacturing management apparatus and method.

### Solution to Problem

The present disclosure provides some embodiments of a sewing design manufacturing management apparatus and method, which can provide a solution to the low efficiency of manufacturing an end product due to the lack of organic association with the design of the end product and the manufacture of the product.

According to an aspect of the present disclosure, disclosed is a sewing design manufacturing management apparatus which includes a design shape display module, a design shape analysis module, a sewing information process module, a sewing data process module, a manufacturing prediction module, a factory line process module, a network interface module, an input/output module, and an after-service (A/S) module.

According to another aspect of the present disclosure, disclosed is a sewing design manufacturing management apparatus which further includes a design layout module.

According to another aspect of the present disclosure, disclosed is a sewing design manufacturing management method which includes receiving design information on an end product to be manufactured by sewing; configuring at least one component shape of the end product based on the design information; identifying one or more processes necessary for manufacturing the end product based on analysis of the one or more component shapes; enabling a user to select one process from the one or more processes; enabling a user to select one process from the processes; providing one or more process task charts related to the one or more processes; predicting at least one of process time and process cost for the selected process, on the basis of the sewing information and the sewing data; transmitting at least one of the sewing information and the sewing data to at least one sewing manufacturing device through a network; receiving a device status message from the at least one sewing manufacturing device, the device status message including an abnormal status message indicating that a status of the at least one sewing manufacturing device is abnormal; providing at least one of text data and multi-media data to address the abnormal status based on the abnormal status message; and transmitting an A/S request message to a sewing manufacturing device provider based on the abnormal status message.

A design manufacturing management method according to another embodiment of the present disclosure further includes generating design information.

The following detailed description includes various exemplifications that can implement the present disclosure. The disclosed exemplifications merely facilitate the understanding of the content of the present disclosure, and do not limit the present disclosure at all. The present disclosure may include an embodiment which is implemented with only software, include an embodiment which is implemented with only hardware, or include an embodiment which is implemented by combining software and hardware. Also, elements or operations that are separately described in one embodiment of the present disclosure may be integrated as one element or one operation in another embodiment.

According to an embodiment of the present disclosure, it is possible to enable a user to easily provide information on a plurality of sewing processes necessary for manufacturing a product and sewing data for a plurality of manufacturing devices that perform the sewing processes, on the basis of information on an end product design to be manufactured by sewing. Also, an embodiment of the present disclosure makes it possible to accurately predict the manufacturing time and the manufacturing cost for manufacturing the end product based on the provided sewing data and information on the sewing processes. According to an embodiment of the present disclosure, the user can select a plurality of manufacturing devices necessary for manufacturing a corresponding product based on the end product design information, and when a desired manufacturing device is not available, the user can ask a manufacturing device provider to deliver the corresponding manufacturing device. Moreover, an embodiment of the present disclosure may propose a factory line configuration, change, or rearrangement of workers in order to meet the required manufacturing cost and delivery date. Further, an embodiment of the present disclosure may receive a message indicating that the status of a sewing manufacturing device is abnormal, provide information necessary to address the abnormal status in the form of text data or multimedia data, and transmit an A/S request to a sewing manufacturing device provider.

A sewing design manufacturing management system according to an embodiment of the present disclosure will be described in detail with reference to FIG. 1. In a sewing design manufacturing management system 100, a sewing design manufacturing management apparatus 110 may be connected to a design layout module 180 over a first network 150, may be connected to a plurality of sewing manufacturing devices 190-1 to 190-n over a second network 152, and may be connected to an outside network over a third network 154. In an embodiment, the first network 150 and the second network 152 may include at least one of a dedicated Local Area Network (LAN) connection, a wide area network connection, a Public Switched Telephone Network (PSTN) connection, and a wireless communication connection, but the present embodiment is not limited thereto. The first to third networks 150 to 154 may be operated according to a known network protocol such as Transmission Control Protocol/Intent Protocol (TCP/IP), File Transfer Protocol (FTP), or Hypertext Transport Protocol (HTTP), but the present disclosure is not limited thereto.

As illustrated in FIG. 1, the sewing design manufacturing management apparatus 110 according to an embodiment of the present disclosure may include a network interface 136. The network interface 136 may receive design information from the design layout module 180 over the first network 150, and transmit device operation information to the sewing manufacturing devices 190-1 to 190-n over the second network 152. The network interface 136 may transmit/receive relevant data and information to and from an external network over the third network 154. In an embodiment, the network interface 136 may access a network of the sewing manufacturing device provider over the third network 154 to request or receive information on a new manufacturing device or A/S. The network interface 136 may demodulate a plurality of signals for extracting design information included in a plurality of carrier signals, or modulate a plurality of signals to transmit the device operation information, thereby enabling an exchange of data over the first and second networks 150 and 152. In addition to the modulation and demodulation, the network interface 136 may include an encryption module for maintaining security.

The sewing design manufacturing management apparatus 110 according to an embodiment of the present disclosure may include a design shape display module 122. The design shape display module 122 may generate at least one shape for a component for a corresponding end product based on the sewing design information that is received over the first network 150. The sewing design information provided by the design layout module 180 may be used to determine an external shape of the end product, as with three-dimensional (3D) CAD data, but may not be used for seeing shapes of numerous product components that will be used to manufacture the corresponding end product. Therefore, the design shape display module 122 may provide data representing at least one shape of a component for the end product based on the sewing design information, thereby enabling a user to visually and easily input sewing information and data necessary for manufacturing the end product.

The sewing design manufacturing management apparatus 110 according to an embodiment of the present disclosure may further include a design shape analysis module 124. The design shape analysis module 124 may analyze design information, for extracting at least one shape of a component for the end product from the sewing design information. Such an analysis may include a conversion from 3D data to two-dimensional (2D) data and performing an analysis for each component for a sewing design, based on information on the components necessary for manufacturing the end product. For example, in order to make it easier to manufacture the end product, the design shape analysis module 124 may generate and provide a 2D representation through data conversion from the 3D sewing design information, to provide a plan view for each component of the end product and present each work process in a clear manner.

The sewing design manufacturing management apparatus 110 according to an embodiment of the present disclosure may further include a sewing information process module 126. The sewing information process module 126 may provide an individual component shape, which may be provided by the design shape display module 122, to a user. With the individual component shape, the sewing information process module 126 enables the user to easily input sewing information on each process. Sewing information received at the sewing information process module 126 may include a stitch shape, a member to be used in each sewing processing section, a type and color of yarn, a needle, a stitch length, a total number of stitches, a start and end position of each section, an accessory attachment type, and other guidelines/cautions of sewing, but the present embodiment is not limited thereto. The sewing information process module 126 may separately store sewing information, which is received from a user, for each section in each process.

The sewing design manufacturing management apparatus 110 according to an embodiment of the present disclosure may further include a sewing data process module 128. The sewing data process module 128 enables a user to provide sewing data, which is required for performing a corresponding sewing process, based on the sewing information stored in the sewing information process module 126. The sewing data may include a plurality of parameters for executing a component stitch pattern for each sewing process, and specifically include a stitch width, a number of stitches, an upper yarn tension, a sewing speed, a sewing machine foot pressure, etc., but the sewing data is not limited thereto. The sewing parameters may need to be adjusted according to the sewing manufacturing device that is used in a corresponding sewing process, and thus, the sewing data process module 128 may allow a user to select a sewing manufacturing device to be used. When a sewing manufacturing device that a user desires to use is not available, the sewing data process module 128 may transmit an inquiry or a request for a corresponding sewing manufacturing device to a provider. For example, when a user selects a non-available sewing manufacturing device, the sewing data process module 128 may allow for a purchase inquiry or request interface to be displayed. The purchase inquiry or request interface may operate in operational connection with a social network service such as Twitter or Facebook.

The sewing design manufacturing management apparatus 110 according to an embodiment of the present disclosure may further include a manufacturing prediction module 132. The manufacturing prediction module 132 may predict working hours for each process on the basis of the total number of stitches, start and end positions, number of yarn cuttings, and main shaft speed, which are designated for each sewing process. The manufacturing prediction module 132 may predict total manufacturing time or manufacturing cost that is expected in manufacturing an end product, in consideration of the order of assembling components, number of used manufacturing devices, daily predicted working hours, and worker wages.

The sewing design manufacturing management apparatus 110 according to an embodiment of the present disclosure may further include an input/output module 134. The input/output module 134 may include an input means for receiving a command and information from a user. In an embodiment, the input means may include a keyboard, a pointing device, a microphone, a joystick, a scanner, etc., but the present embodiment is not limited thereto. The input/output module 134 may include an output means for providing information to a user. For example, the output means may include a monitor display, a speaker, a printer, etc., and include a wired/wireless interface that transfers an information signal to be outputted to a user personal terminal, but the present embodiment is not limited thereto. A user may be provided with an interface, which may receive sewing information or sewing data from the sewing design manufacturing management apparatus 110 according to an embodiment of the present disclosure, thereby enabling the user to input corresponding information and data via the input means or the output means.

The sewing design manufacturing management apparatus 110 according to an embodiment of the present disclosure may further include an A/S module 138. The A/S module 138 may receive a device status message from the sewing manufacturing devices 190-1 to 190-n over the second network 152. The device status message may include an abnormal status message indicating that the status of the sewing manufacturing devices 190-1 to 190-n is abnormal, and the abnormal status message may include information to recognize each of the sewing manufacturing devices 190-1 to 190-n and provide details about the abnormal status. The A/S module 138 may provide the sewing manufacturing devices 190-1 to 190-n over the second network 152 with information necessary to address the abnormal status based on the details, for example, in the form of text data or multimedia data. In accordance with the information included in the text data or the multimedia data, the sewing manufacturing devices 190-1 to 190-n may be adjusted or configured by taking appropriate measures. Even after the adjustment or configuration, if the abnormal status continues, the A/S module 138 may transmit an A/S request message to a sewing manufacturing device provider over the third network 154. After transmitting the A/S request, the A/S module 138 may monitor the A/S progress. According to one embodiment of the present disclosure, the A/S module 138 may check the time from the A/S request transmission to the arrival of an A/S personnel, the status of the A/S progress, the completion of the A/S, etc.

The sewing design manufacturing management apparatus 110 according to an embodiment of the present disclosure may further include a central process module 120. The central process module 120 may control the elements of the sewing design manufacturing management apparatus 110 and issue a command, in order to perform a series of procedures necessary for the management of a sewing design. According to an embodiment of the present disclosure, the central process module 120 may be a general computer, a special purpose computer, a distributed processing system, or an independent operation processing device, but the present embodiment is not limited thereto.

In the sewing design manufacturing management system 100 according to an embodiment of the present disclosure, the sewing manufacturing devices 190-1 to 190-n may include controllers 180-1 to 180-n and display devices 182-1 to 182-n, respectively. The controllers 180-1 to 180-n of the sewing manufacturing devices may receive at least one of the sewing information and the sewing data over the second network 152 and set operating conditions on the basis of the at least one of the sewing information and the sewing data. The display devices 182-1 to 182-n of the sewing manufacturing devices may include a monitor for visual data, a speaker for audio data, an input module (e.g., a touch panel) for receiving a user input, etc. With these means, the display devices 182-1 to 182-n may provide a user with information and requirements that should be kept in mind with regard to the sewing information and the sewing data. In addition, the controllers 180-1 to 180-n of the sewing manufacturing devices may transmit manufacturing status information to the sewing design manufacturing management apparatus 110 over the second network 152.

In the sewing design manufacturing management system 100 according to an embodiment of the present disclosure, the controllers 180-1 to 180-n of the sewing manufacturing devices may transmit the device status message to the A/S module 138 over the second network 152. The device status message may include the abnormal status message indicating that at least one of the sewing manufacturing devices 190-1 to 190-n enters the abnormal status. The sewing manufacturing devices 190-1 to 190-n may receive the text data or multimedia data regarding the abnormal status from the A/S module 138. The display devices 182-1 to 182-n of the sewing manufacturing devices 190-1 to 190-n may display the received text data or multimedia data depending on a user's request received from the input module.

FIG. 2 is a block diagram illustrating a sewing design manufacturing management system 100 according to another embodiment of the present disclosure. FIG. 2 illustrates the sewing design manufacturing management system 100 where a design layout module 180 is included in a sewing design manufacturing management apparatus 110. In such an embodiment, when an end product design is transferred in the form of a sketch or a document, the sewing design manufacturing management apparatus 110 may directly generate sewing design information with the design layout module 180. The sewing design information generated by the design layout module 180 may be transferred to a design shape display module 122 and a design shape analysis module 124, thereby performing management of a design layout, as described above with reference to FIG. 1.

A sewing design manufacturing management method according to an embodiment of the present disclosure will be described in detail with reference to FIG. 3.

The sewing design manufacturing management method is started in operation 302, and may receive sewing design information from the outside through a network or a medium such as a storage device in operation 304. In an embodiment, the sewing design information may be 3D digital information generated by a CAD program, but the present embodiment is not limited thereto.

In operation 306, the sewing design manufacturing management method may analyze the sewing design information that was received in operation 304, and thus determine a plurality of processes necessary for manufacturing a corresponding end product. In an embodiment, in order to extract at least one component shape of the corresponding end product by analyzing the sewing design information, the sewing design manufacturing management method may perform a conversion operation from 3D data into 2D data, but the operation for extracting at least one component shape is not limited thereto. Also, according to an embodiment of the present disclosure, the sewing design manufacturing management method may divide the sewing design information into that necessary for each process for manufacturing the product, and analyze each of the components used in the process. For example, in a child safety seat, the sewing design manufacturing management method may analyze each of components such as a seat cushion, a seat back, and a head rest.

In operation 308, the sewing design manufacturing management method may display a sewing design shape necessary for manufacturing a product, on the basis of the analysis of the sewing design information that was obtained in operation 306. According to an embodiment of the present disclosure, the sewing design shape may be displayed on a process basis or a component basis, but the present disclosure is not limited thereto. According to an embodiment of the present disclosure, a plurality of components may be assembled to result in an intermediate product, and then, a plurality of intermediate products may be integrated to result in a secondary intermediate product or a finally finished product. Therefore, in operation 308, in which the sewing design shape is displayed, the sewing design manufacturing management method may display not only the shape of each component, but also the shapes of a plurality of intermediate products, which are produced in a sewing process operation. The shapes displayed in operation 308 may be stored respectively as an independent object, and displayed according to a user's request.

In operation 310, in accordance with an embodiment of the sewing design manufacturing management method, sewing information and sewing data may be inputted with reference to the sewing design shape displayed in operation 308. The displayed design shape may be identified on the basis of processes necessary for manufacturing the end product, and the sewing information and sewing data may include parameters, materials, members, attachment devices, and cautions that are required respectively for each process, but the present disclosure is not limited thereto. Specifically, with reference to the displayed design shape, the sewing design manufacturing management method may allow a user to input information such as a stitch shape, a member to be used, a type and color of yarn, a needle, a stitch length, a total number of stitches, start and end positions of each section, an accessory attachment type, and other guidelines and cautions of sewing in operation 310, but the input sewing information is not limited thereto. Also, with reference to the displayed design shape and the input sewing information, the sewing design manufacturing management method may allow the user to input the sewing data such as a stitch width, a number of stitches, an upper yarn tension, a sewing speed, and a sewing machine foot pressure in operation 310. According to an embodiment of the present disclosure, the sewing design manufacturing management method may receive the sewing data, and allow the user to select a sewing manufacturing device for performing a sewing process on the basis of the sewing data. When the selected sewing manufacturing device is not included in a manufacturing factory, the sewing design manufacturing management method may provide an interface that allows the user to transmit a purchase inquiry or request to a sewing manufacturing device provider who provides a corresponding sewing manufacturing device, or transmit the purchase inquiry or request through a social network service such as Twitter or Facebook in operation 310, but a scheme of transmitting the purchase inquiry or request is not limited thereto.

In operation 312, the sewing design manufacturing management method may transmit the sewing information and data, which were inputted in operation 310, to a corresponding sewing manufacturing device. According to an embodiment of the present disclosure, in operation 312, the transmitted sewing information and data may be received by the sewing manufacturing device and automatically set the operation environment of the sewing manufacturing device, such as an upper yarn tension, a sewing speed, a sewing machine foot pressure and the like. Guidelines/cautions may be displayed on a display means that is included in the sewing manufacturing device, and thus, easily provided to a worker. The sewing manufacturing device, which has been configured with the sewing information and the sewing data transmitted in operation 312, may even be operated by an unskilled beginner, instead of a skilled worker.

In operation 314, the sewing design manufacturing management method may be completed.

A sewing design manufacturing management method according to another embodiment of the present disclosure will be described in detail with reference to FIG. 4.

The sewing design manufacturing management method according to another embodiment of the present disclosure may start in operation 402, and may allow for configuring a sewing design in operation 404. In operation 404, for example, the sewing design may be transferred to a manufacturer in the form of a sketch or document. According to the sewing design manufacturing management method, design information necessary for manufacturing a product may be generated based on the sketch or the document.

In operation 406, the sewing design information generated in operation 404 may be analyzed to identify a plurality of processes necessary for manufacturing a corresponding end product. In operation 408, sewing information and sewing data necessary for manufacturing the end product may be inputted for each of the identified processes. In operation 410, the input sewing information and sewing data may be transmitted to a corresponding sewing manufacturing device, thereby enabling even an unskilled worker to operate the manufacturing device for manufacturing the end product. Operations 406 to 410 are similar to operations 306, 310 and 312, respectively, that have been described above with reference to FIG. 3, and thus, the descriptions of operations 306, 310 and 312 are applied to operations 406 to 410, respectively. An embodiment of the present disclosure of FIG. 4 may be completed in operation 412.

FIG. 5 is a function selection interface 500 providing a plurality of functions for sewing design manufacturing management according to an aspect of at least one embodiment of the present disclosure. The function selection interface 500 enables a user to select a design configuration menu 502, thereby allowing the use of a plurality of functions associated with configuring a design, or enables the user to select a design management menu 504, thereby allowing the use of a plurality of functions associated with managing the design. According to an embodiment, when a user selects the design configuration menu 502, the function selection interface 500 enables the user to select at least one of a product design configuration function 510, a product component configuration function 512, a stitch and seam determination function 514, and a design data storage function 516. The product design configuration function 510 may provide an interface function that enables a manufacturer to directly configure a sewing design when design information on an end product is transferred in the form of a sketch or document, or when no design information is provided to the manufacturer. The product component configuration function 512 sets restrictions on respective components for the end product and connection relationships between components, but the present embodiment is not limited thereto. The stitch and seam determination function 514 may set the type and shape of a seam or a stitch that is performed for manufacturing the end product. The design data storage function 516 may store design information content that is generated, corrected, and deleted by a user in a storage device. As described above, the design configuration menu 502 may include the product design configuration function 510, the product component configuration function 512, the stitch and seam determination function 514, and the design data storage function 516, but the present embodiment is not limited thereto.

The design management menu 504 of the function selection interface 500 according to an embodiment of the present disclosure may provide at least one of a file function 520, a sewing information input function 530, a sewing data input function 540, a productivity analysis function 550, and a factory line configuration function 560, but the present embodiment is not limited thereto.

The file function 520, which may be included in the design management menu 504, may include a function to open, store, or upload the design information data to a database, but the present embodiment is not limited thereto.

The sewing information input function 530, which may be included in the design management menu 504, enables a user to input a sewing brand name, a product code, a Bill of Material (BOM) code, a process number, a process name, a type of a sewing manufacturing device, a type and color of yarn, accessory settings, and process information on start and end positions, but the present embodiment is not limited thereto. For example, the sewing information input function 530 enables a user to provide a type of needle, a stitch length, a total number of stitches, a type of sewing manufacturing device, a process code, materials used for each of the sections, and materials used for each of the stitch shapes.

According to an embodiment, the sewing data input function 540 of the design management menu 504 enables a user to input at least one of the following sewing data. As an example, the user may input a seam width, a shape and range of a stitch, a shape of a seam, a sewing speed, a number of stitches, a stitch length, a yarn to be used, an upper yarn tension, a sewing machine foot pressure, a needle, a lockstitch, a type of needle sewing, upper and lower needle sewing, a chain, overlock, zigzag, flat, post, a cylinder, a pattern size, and a bar tack, by using the sewing data input function 540, but the present embodiment is not limited thereto.

The productivity analysis function 550 included in the design management menu 504 enables the reception of information necessary to generate manufacturing information required for the end product. For example, the productivity analysis function 550 may select a sewing manufacturing device to be applied and receive working conditions, daily manufacturing amount, information on each factory line, etc., but the present embodiment is not limited thereto. According to another embodiment, the productivity analysis function 550 may predict and provide the number of sewing manufacturing devices and the number of workers that should be involved for satisfying the requested delivery deadline and the requested amount of manufacturing end products, in consideration of the selected sewing manufacturing device(s) and received working conditions.

The factory line function 560 of the design management menu 504 may be included in at least one embodiment of the present disclosure. The factory line function 560 enables a user to configure, correct, and change a series of sub factory lines and a series of main factory lines, on the basis of sewing information and sewing data that are input in connection with a sewing design.

According to at least one embodiment of the present disclosure, an A/S function 580 may be included in the design management menu 504. The A/S function 580 may provide text data or multimedia data to address a corresponding abnormal status based on an abnormal status received from a sewing manufacturing device, but the present embodiment is not limited thereto. The A/S function 580 may generate an A/S request message, which may be transmitted to a sewing manufacturing device provider, and allow a user to review and revise the A/S request message. Further, the A/S function 580 may monitor how far the requested A/S has completed and check whether the A/S is completed within a desired time. The review and revision of the A/S request message and the monitoring of the A/S will be explained below in more detail.

FIG. 6 illustrates an example of an interface illustrating a plurality of shapes, which respectively represent a plurality of components on the basis of design information on an end product, according to at least one embodiment of the present disclosure. In an embodiment of FIG. 6, a plurality of components to be used for manufacturing a child safety seat are illustrated in view of the child safety seat design. For example, the child safety seat may include components such as a seat cushion 610, a seat back 612, and a head rest 614, but the present embodiment is not limited thereto. In FIG. 6, as an example, a series of cloth cuttings that configure each component are illustrated in a plan view.

FIG. 7 is a diagram illustrating an interface example that displays a plurality of process task charts generated on the basis of a sewing design shape, according to at least one embodiment of the present disclosure. As an example, FIG. 7 illustrates a series of processes 702-1 to 702-n for manufacturing a child safety seat. The processes 702-1 to 702-n of FIG. 7 are displayed in the form of thumbnails, but the present embodiment is not limited thereto. In an embodiment of FIG. 7, a user may select a thumbnail box of a desired process with a selection icon 750 that is movable by using a pointing device. In FIG. 7, the selection icon 750 is displayed in the shape of an arrow, but the present embodiment is not limited thereto. As another example, the selection icon 750 may be displayed in the form of a graphic or animation such as a finger, a pen, a pin or the like. A thumbnail box with the selection icon 750 disposed therein may protrude greater than the other thumbnail boxes, or change in the border color of the thumbnail box, and the process presented by the thumbnail box may be indicated as being selected. According to another embodiment, a thumbnail box selected by the selection icon 750 may move, rotate at certain angles, or blink, thereby displaying the selection of the thumbnail box. However, a selection display scheme according to the present embodiment is not limited thereto. While the selection icon 750 is disposed on a specific thumbnail box, for example, while the selection icon 750 is disposed on one process 702-9 for the child safety seat as illustrated in FIG. 7, by clicking or designating the process 702-9 with an input device such as a pointing device, a user may access other functions in connection with the process 702-9 according to at least one embodiment of the present disclosure. Examples of other usable functions according to an embodiment of the present disclosure are illustrated in FIGS. 8 to 11.

FIG. 8 is a diagram illustrating an example of a process information input interface 800, according to at least one embodiment of the present disclosure. The process information input interface 800 may include: a full view 802 displaying at least one component associated with a corresponding process in its entirety; a zoom view 804 enlarging and displaying only an desired portion of the full view 802; and a plurality of input menus 802 to 808 enabling the input of corresponding process information, but the present embodiment is not limited thereto. The full view 802 may include a zoomed portion sign 850 indicating a portion of the full view 802 currently displayed on the zoom view 804. A user may directly input process information on a corresponding sewing process, or select one of a plurality of menus that are provided in an embodiment of the present disclosure. For example, a user may select a seam width input window 812 that enables the input of a seam width necessary for a corresponding process, and directly input a seam width to a seam width box 812-1. Also, the user may select a stitch shape input window 814 for selecting the shape of a stitch in a corresponding process, and, by clicking a stitch shape selection tab 814-1, the user may select one of a plurality of provided stitch shapes. Even for a seam shape and a 3D stitch that are necessary for a corresponding process, similar to the stitch shape, by clicking a seam shape selection tab 816-1 and 3D stitch shape selection tab 818-1, the user may select one of at least one seam shapes and 3D stitch shapes that are provided in the tabs. According to another embodiment of the present disclosure, a user may select one of a plurality of usable seam widths that are provided in a selection tab enabling the selection of a seam width, or directly input a stitch shape, a seam shape, and a 3D stitch shape.

FIG. 9 is a diagram illustrating another example of a process information input interface 900, according to at least one embodiment of the present disclosure. According to an embodiment, the process information input interface 900 may include a full view 902 displaying at least one component in its entirety in association with a corresponding process, and a zoom view 904 enlarging and displaying the full view 902, but the present embodiment is not limited thereto. Some portions of the full view 902 necessary for certain sewing work in a corresponding process may be emphasized and enlarged, and the enlarged portions may be displayed on the zoom view 904, but the present embodiment is not limited thereto. The process information input interface 900 may further include a process information input window 912 that enables the input of information on a corresponding process. The process information input window 912 may receive a product name, a product code, a process number, a process name, a BOM code, a type of a sewing manufacturing device, a stitch shape and materials to be used in each section, a type and color of yarn, a type of a needle, a stitch length, a total number of stitches, an accessory attachment type, and other work guidelines, but the present embodiment is not limited thereto. Also, the process information input interface 900 enables a user to set start and end positions in each process section. For example, a start position setting button 912-1 and an end position setting button 912-2 may be provided to the process information input window 912 of the process information input interface 900, but the present embodiment is not limited thereto. In an embodiment, a user may click the start position setting button 912-1, move a pointing device to a desired position in the zoom view 904, and click the desired position, thereby setting a start position of a corresponding process section. Similarly, the user may click the end position setting button 912-2, move the pointing device to a desired end position in the zoom view 904, and click the desired end position, thereby setting the end position. As an example, the set start position and end position are displayed on the zoom view of FIG. 9.

FIG. 10 is a diagram illustrating an example of a sewing data input interface 1000, in association with at least one embodiment of the present disclosure. The sewing data input interface 1000 may display process information associated with sewing data, and thus, enable a user to associate sewing data to be inputted with the process information. The process information may include a process number, a process name, a product code, a BOM code, a work zone, a seam width, a stitch shape, a seam shape, a 3D stitch shape, and other work guidelines that are illustrated on the input interface 1000 of FIG. 10, but the present embodiment is not limited thereto. The sewing data input interface 1000 may provide a plurality of windows that enable a user to input relevant sewing data on the basis of the illustrated process information. For example, the sewing data input interface 1000 may enable a user to input a sewing speed, a number of stitches, a stitch length, a type and tension of upper yarn, a type of lower yarn, a needle to be used, and a sewing machine foot pressure, by using a sewing condition input window 1002. The sewing data input interface 1000 of FIG. 10 may provide a usable machine window 1004 that enables a user to select a sewing manufacturing device, which performs a process according to a corresponding sewing condition, on the basis of sewing condition data that is inputted with the sewing condition input window 1002. The usable machine window 1004 may include a sewing type selection box 1004-1 and a shape type selection box 1004-2, and thus, enable a user to select the desired sewing and shape types. Also, the usable machine window 1004 may include a machine selection box 1004-3 that enables a user to select a sewing manufacturing device on the basis of at least one of the selected sewing and shape types. However, the present embodiment is not limited thereto. According to another embodiment of the present disclosure, when a sewing manufacturing device selected by a user is not available, the usable machine selection box 1004-3 may provide a means for transmitting an inquiry and a manufacturing request for a corresponding sewing manufacturing device to a device provider. For example, the usable machine selection box 1004-3 may generate a new window providing access to a website of a corresponding sewing manufacturing device provider, a window enabling the input of an inquiry for a corresponding sewing manufacturing device, or a window connecting to a social network service such as Twitter or Facebook, but the present embodiment is not limited thereto.

FIG. 11 is a diagram illustrating an example of a sewing process time and cost prediction interface 1100, according to at least one embodiment of the present disclosure. The sewing process time and cost prediction interface 1100 may include a window 1102 displaying at least one sewing manufacturing device used in manufacturing a corresponding end product, a window 1104 displaying daily working conditions in manufacturing the corresponding end product, and a window 1106 displaying an additional time percentage other than sewing process, but the present embodiment is not limited thereto. Also, the sewing process time and cost prediction interface 1100 may further include a process list button 1108 and a daily required manufacturing amount button 1110. When a user selects the process list button 1108, as illustrated in FIG. 11, a process list 1150 for manufacturing the corresponding end product may be displayed. When the daily required manufacturing amount button 1110 is selected, the sewing process time and cost prediction interface 1100 enables a user to input a daily required manufacturing amount for the corresponding end product. The process list 1150 of FIG. 11 may classify a plurality of components configuring the corresponding end product into one component group and display a plurality of processes for each group. For example, the process list 1150 of FIG. 11 may classify a child safety seat into a seat cushion, a seat back, and a head rest as respective component groups and display a plurality of processes for each component group, but the present embodiment is not limited thereto. The process list 1150 of FIG. 11 may predict process time on the basis of a stitch length, a number of stitches, start and end positions of each process section, a number of yarn cuttings, a number of yarn cuttings set in a sewing manufacturing device, and a number of sewing manufacturing devices involved in each corresponding process; predict process cost on the basis of daily working conditions and the number of workers; and display the predicted process time and the predicted process cost. The manufacturing time and cost to be expected in manufacturing a corresponding end product may be produced by summing the predicted working hours and the predicted manufacturing cost for each component group for the end product, as displayed in the process list 1150 of FIG. 11. For example, the manufacturing time and manufacturing cost to be expected for manufacturing the child safety seat are illustrated at a lower portion of the process list 1150 of FIG. 11.

FIG. 12 is a diagram illustrating another example of a sewing working time and cost prediction interface 1200, in accordance with at least one embodiment of the present disclosure. The sewing working time and cost prediction interface 1200 of FIG. 12 may include an M/C information window 1202, a window 1204 displaying daily working conditions, and a window 1206 displaying an additional time rate irrespective of a sewing process, but the present embodiment is not limited thereto. Also, the sewing working time and cost prediction interface 1200 may further include a process list button 1208 and a daily required manufacturing amount button 1210. The windows and buttons included in the sewing working time and cost prediction interface 1200 of FIG. 12 may perform respective functions similar to the windows and buttons that are included in the above-described sewing process time and cost prediction interface 1100 of FIG. 11. The sewing working time and cost prediction interface 1200 of FIG. 12 provides a process prediction table 1250 for each of the sewing manufacturing devices. The process prediction table 1250 for each of the sewing manufacturing devices provides results obtained by calculating the number of processes, sewing hours, and working hours (which are performed by at least one sewing manufacturing device that is used to manufacture a corresponding end product) according to sewing data and sewing information that are received from a user. The process prediction table 1250 for each of sewing manufacturing devices may be used to determine whether an additional sewing manufacturing device is required for satisfying the required manufacturing amount of end products. For example, the sewing hours and working hours can be predicted assuming that only the currently available sewing manufacturing device “KM-1170BLX” of FIG. 12 is used, and the sewing hours and working hours can be calculated assuming that new devices are added to the currently available sewing manufacturing devices. By comparing these calculated sewing hours and working hours, it would be possible to determine the number of sewing manufacturing devices necessary for providing the ordered manufacturing amount of end products by the predetermined delivery deadline. In another embodiment, by changing conditions associated with daily working conditions 1204, for example, by changing conditions such as working hours or meeting/breaking hours, it would be possible to check a time to deliver an ordered manufacturing amount of the products.

FIG. 13 is a diagram illustrating an example of a sewing factory line configuration interface 1300, in accordance with at least one embodiment of the present disclosure. The sewing factory line configuration interface 1300 may display the position of at least one factory line used to manufacture an end product, the arrangement of at least one sewing manufacturing device that configures each factory line, working flow lines for each factory line, and at least one component of the end product, but the present embodiment is not limited thereto. The sewing factory line configuration interface 1300 of FIG. 13 displays three types of sewing factory lines, including a front seat cushion factory line 1302, a front seat back factory line 1304, and a head rest factory line 1306. In each of the sewing factory lines, a working flow line is illustrated with an arrow. According to an embodiment of the present disclosure, the sewing factory line configuration interface 1300 may enable a user to correct the position of a sewing factory line, the arrangement of a sewing manufacturing device, and the traffic line of a factory line by using a pointing device.

An A/S management method for the sewing manufacturing devices 190-1 to 190-n in the sewing design manufacturing management system according to an embodiment of the present disclosure will be described with reference to FIG. 14.

The A/S management method is started in operation 1402, and may receive a device status message from at least one of the sewing manufacturing devices 190-1 to 190-n over a network. In operation 1406, the A/S management method may determine whether an abnormal status message is included in the device status message. If the abnormal status message is included, the A/S management method may proceed to operation 1408. If not, the A/S management method may proceed to operation 1404 to receive another device status message. In operation 1408, the A/S management method may provide text data or multimedia data including information to address the corresponding abnormal status. In accordance with the text data or the multimedia data, a sewing manufacturing device may be adjusted by taking proper measures to address the abnormal status. In operation 1410, the A/S management method may determine whether the abnormal status is addressed with the taken measures according to the text data or the multimedia data. If the abnormal status is not addressed, the A/S management method may proceed to operation 1412, and if the abnormal status is addressed, the method may return to operation 1404 to receive a new device status message. In operation 1412, the A/S management method may generate and transmit an A/S request for the abnormal status to a sewing management device provider. After transmitting the A/S request, the A/S management method may continue to monitor the progress of the A/S until the A/S is finished in operation 1414. The A/S management method may be completed in operation 1415 when the A/S is completed.

FIG. 15 is a diagram illustrating an example of a sewing manufacturing device status interface 1500, according to at least one embodiment of the present disclosure. The sewing manufacturing device status interface 1500 may display a sewing manufacturing device transmitting an abnormal status message. According to an embodiment of the present disclosure, the sewing manufacturing device status interface 1500 may include a line field 1502 indicating a factory line where a sewing manufacturing device is located, a model field indicating a type of a sewing manufacturing device, an error code field, an occurrence time field 1508 indicating the time when an abnormal status message was generated, a description field 1510 describing an abnormal status, etc. In addition, the sewing manufacturing device status interface 1500 may include a self-maintenance field 1512 providing information necessary to address the abnormal status. When a user clicks a self-maintenance field icon, the self-maintenance field 1512 may provide information necessary to address the abnormal status in the form of text or multimedia data. The sewing manufacturing device status interface 1500 may further include a progress field 1514 indicating an A/S status for a sewing manufacturing device with an abnormal status. According to an aspect of at least one embodiment of the present disclosure, when a user clicks a progress icon, the progress field 1514 may indicate whether an A/S request is transmitted or not, how much a A/S has progressed, etc. The sewing manufacturing device status interface 1500 may further include an A/S completion field 1516 indicating that the A/S is completed.

FIG. 16 is a diagram illustrating an example of text data 1600 to be provided to a user based on an abnormal status transmitted from a sewing manufacturing device. The text data 1600 may include machine information 1602 indicating a type and a serial number of a sewing manufacturing device that transmitted the abnormal status message, a control box, an error code, a description on the abnormal status, etc. The text data 1600 may provide a search box 1650 enabling a user to input a keyword associated with the status, an instrumental status display portion 1604, and a control status display portion 1606, which displays the status of the instrumental portion and the control portion according to the input keyword. The text data 1600 may include an instrumental cause display portion 1608 and a control cause display portion 1610, which display the causes for the respective status. The text data 1600 may further include an instrumental measure display portion 1612 and a control measure display portion 1614 so than a user may apply to a sewing manufacturing device with the abnormal status the measures displayed in the instrumental measure display portion 1612 and the control measure display portion 1614 on the basis of the above status and causes. For example, it would be possible to take a measure to the instrumental portion, such as resetting for smooth operation and removing any gaps, and take a measure to the control portion, such as checking connections at a step board connector. A measure completion button 1660 may be provided for a user to indicate that the abnormal status has been addressed as a result of applying such measures to a sewing manufacturing device. An A/S request button 1670 may be provided for a user to request A/S when the abnormal status has not been addressed.

FIG. 17 is a diagram illustrating an example of multimedia data 1700 to be provided a user based on an abnormal status transmitted from a sewing manufacturing device. The multimedia data 1700 may include information necessary to address the abnormal status of a sewing manufacturing device in the form of multi-media data, including a moving picture, sound data, a picture, a hologram, etc. in view of the abnormal status message. For example, the multimedia data 1700 may include a picture showing a measure to address an abnormal status, and a moving picture explaining to a user a necessary measure.

FIG. 18 is a diagram illustrating an example of an A/S request 1800 that may be transmitted to a sewing manufacturing device provider. The A/S request 1800 may include information on a sewing manufacturing device with an abnormal status. For example, the A/S request message 1800 may include a name of a customer 1804 owning a sewing manufacturing device, a type of a sewing manufacturing device 1806, a serial number 1808, a control box number 1810, a factory line number 1812 for the sewing manufacturing device, and data of the device installation 1814. The A/S request message 1800 may further include an A/S providing area 1830, an address 1832, a phone number 1834, and a paid/free service indicator 1836. The A/S request message 1800 may further include information necessary to provide proper A/S. For example, the A/S request message 1800 may include an error code 1816 corresponding to an abnormal status, a status description 1818, a self-maintenance description 1829 indicating a measure taken for addressing the abnormal status, etc. The A/S request message 1800 may include an A/S request button 1850 enabling a user to input a command for transmitting an A/S request after reviewing the contents included in the message.

The sewing design manufacturing management apparatus and method according to the embodiments of the present disclosure may be implemented with a computer program. The computer program may be stored in a computer-readable medium. A computer-readable medium including a computer program according to an embodiment of the present disclosure includes ROM, RAM, flash memory, CD-ROM, optical storage medium such as DVD, hard disk, magnetic storage medium such as magnetic table, and the like, but the present disclosure is not limited thereto. The computer program may include source codes written with programming languages and machine codes compiled by an assembler, but the present disclosure is not limited thereto. The computer-readable medium may store the source codes or the machine codes, as distributed in a plurality of computer systems connected via a network.

While certain embodiments have been described, these embodiments have been presented by way of example only, and are not intended to limit the scope of the disclosures. Indeed, the novel methods and apparatuses described herein may be embodied in a variety of other forms; furthermore, various changes, modifications, corrections, and substitutions with regard to the embodiments described herein may be made without departing from the spirit of the disclosures. Also, the elements and operations of the sewing design manufacturing management apparatus and method of the present disclosure may be implemented as a plurality of distributed hardware modules or software modules.

Therefore, the accompanying claims and their equivalents including the foregoing modifications are intended to cover the scope and spirit of the disclosures, and are not limited by the present disclosures.

### BRIEF DESCRIPTION OF DRAWINGS

FIG. 1 is a block diagram illustrating a sewing design manufacturing management apparatus according to an embodiment of the present disclosure.

FIG. 2 is a block diagram illustrating a sewing design manufacturing management apparatus according to another embodiment of the present disclosure.

FIG. 3 is a flowchart illustrating a sewing design manufacturing management method according to an embodiment of the present disclosure.

FIG. 4 is a flowchart illustrating a sewing design manufacturing management method according to another embodiment of the present disclosure.

FIG. 5 is a block diagram illustrating a plurality of function blocks to manage sewing design manufacturing processes according to at least one embodiment of the present disclosure.

FIG. 6 is a diagram illustrating an example of an interface displaying at least one product component shape based on design information, which is used in association with at least one embodiment of the present disclosure.

FIG. 7 is a diagram illustrating an example of an interface displaying a plurality of process task charts generated on the basis of a sewing design shape, which is used in association with at least one embodiment of the present disclosure.

FIG. 8 is a diagram illustrating an example of a process information input interface, which is used in association with at least one embodiment of the present disclosure.

FIG. 9 is a diagram illustrating another example of a process information input interface, which is used in association with at least one embodiment of the present disclosure.

FIG. 10 is a diagram illustrating an example of a sewing data input interface, which is used in association with at least one embodiment of the present disclosure.

FIG. 11 is a diagram illustrating an example of a sewing process time and cost prediction interface, which is used in association with at least one embodiment of the present disclosure.

FIG. 12 is a diagram illustrating another example of a sewing process time and cost prediction interface, which is used in association with at least one embodiment of the present disclosure.

FIG. 13 is a diagram illustrating an example of a sewing factory line configuration interface, which is used in association with at least one embodiment of the present disclosure.

FIG. 14 is a flowchart illustrating an A/S management method of addressing an abnormal status of a sewing manufacturing device according to at least one embodiment of the present disclosure.

FIG. 15 is a diagram illustrating an example of an A/S management status interface to address an abnormal status of a sewing manufacturing device according to at least one embodiment of the present disclosure.

FIG. 16 is a diagram illustrating an example of text data to address an abnormal status of a sewing manufacturing device according to at least one embodiment of the present disclosure.

FIG. 17 is a diagram illustrating an example of multi-media data to address an abnormal status of a sewing manufacturing device according to at least one embodiment of the present disclosure.

FIG. 18 is a diagram illustrating an example of an A/S request to address an abnormal status of a sewing manufacturing device according to at least one embodiment of the present disclosure.

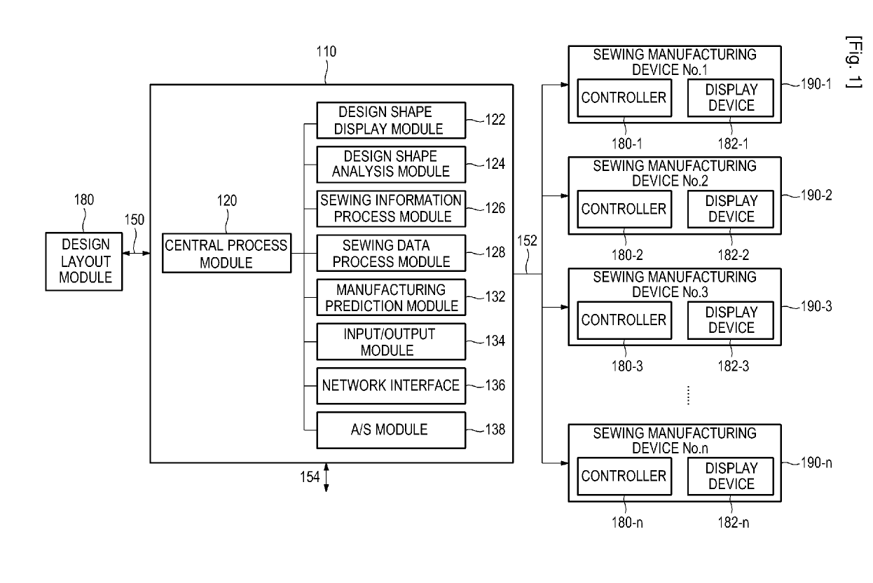

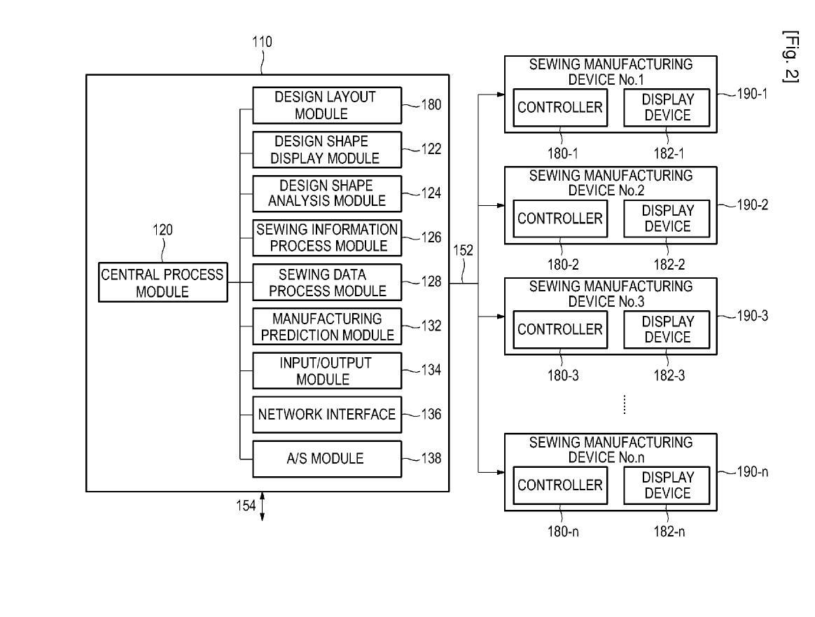

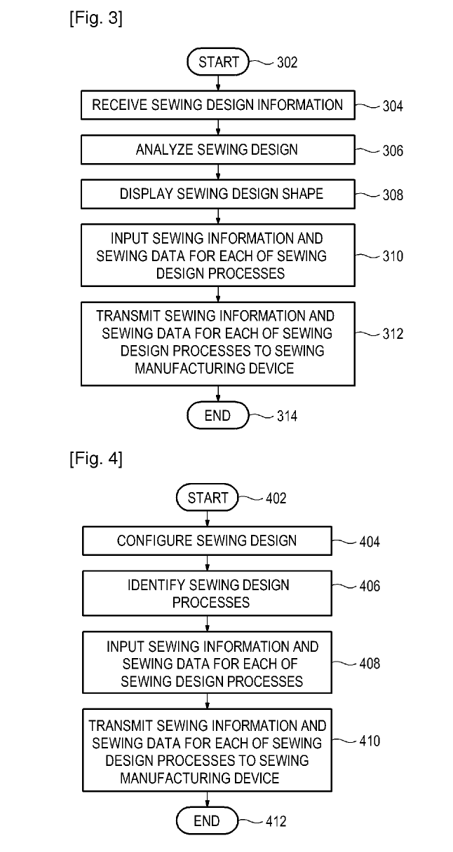

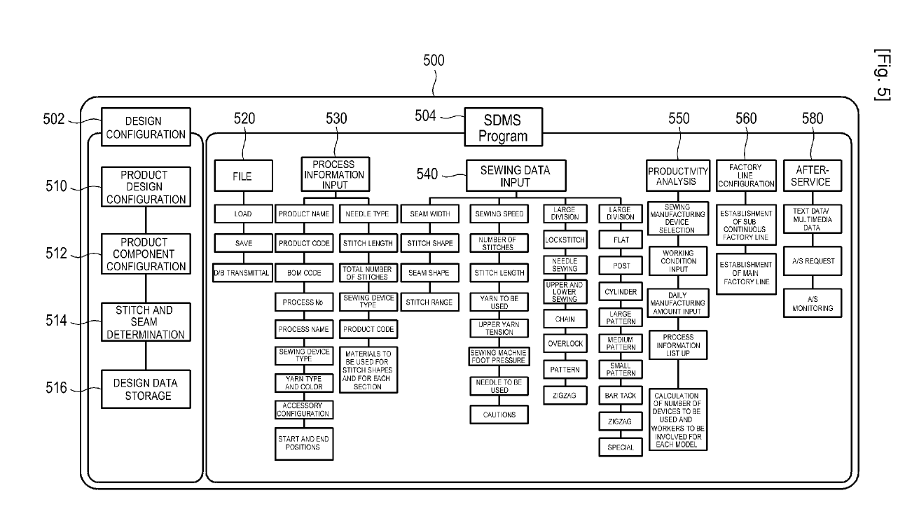

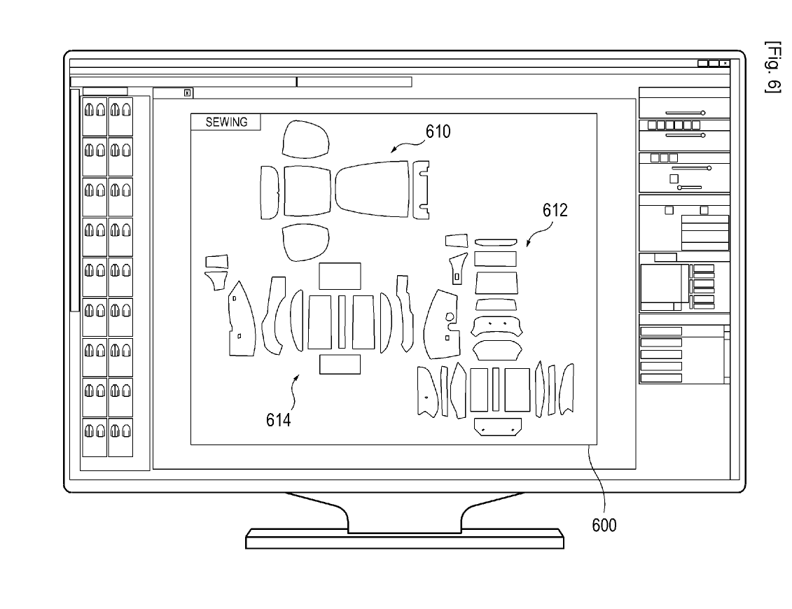

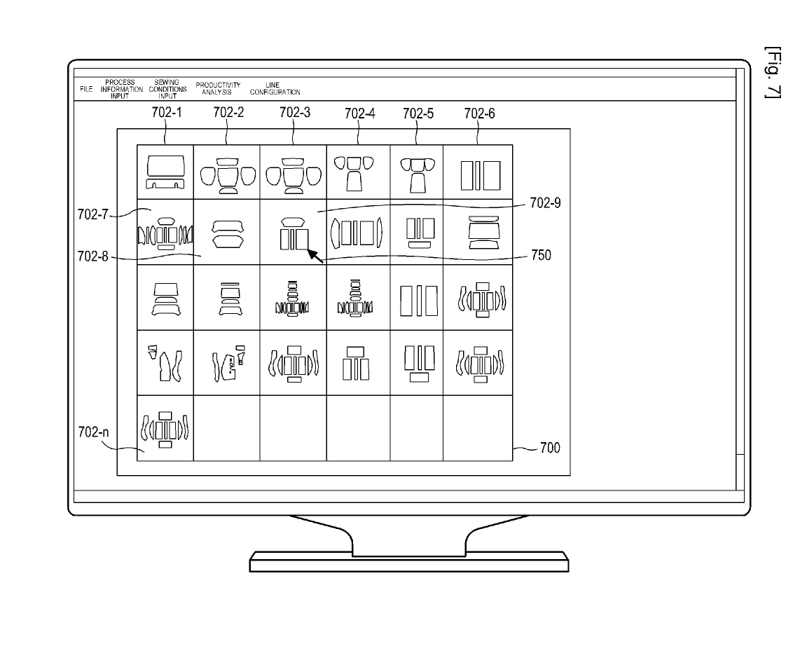

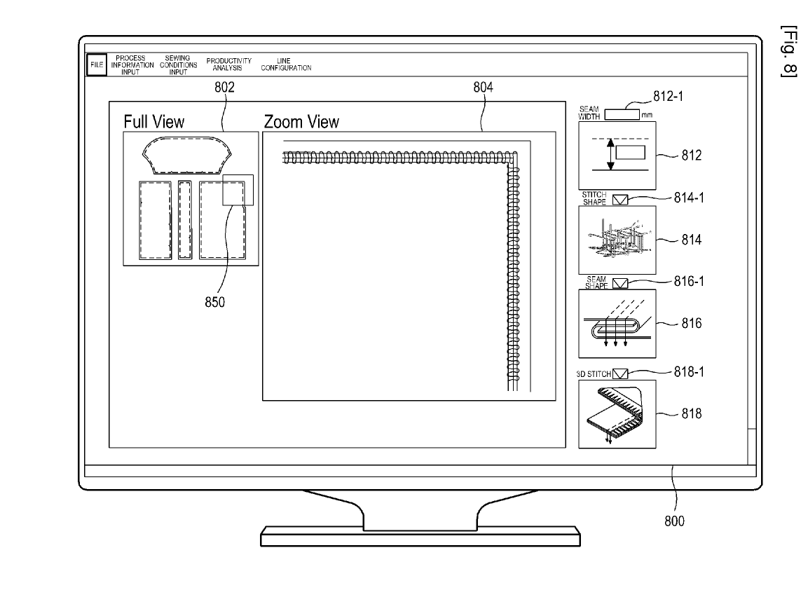

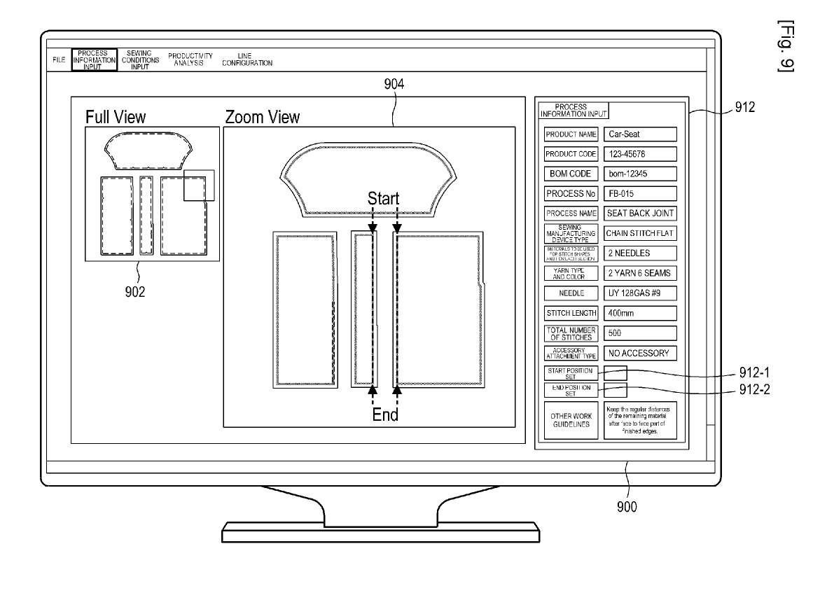

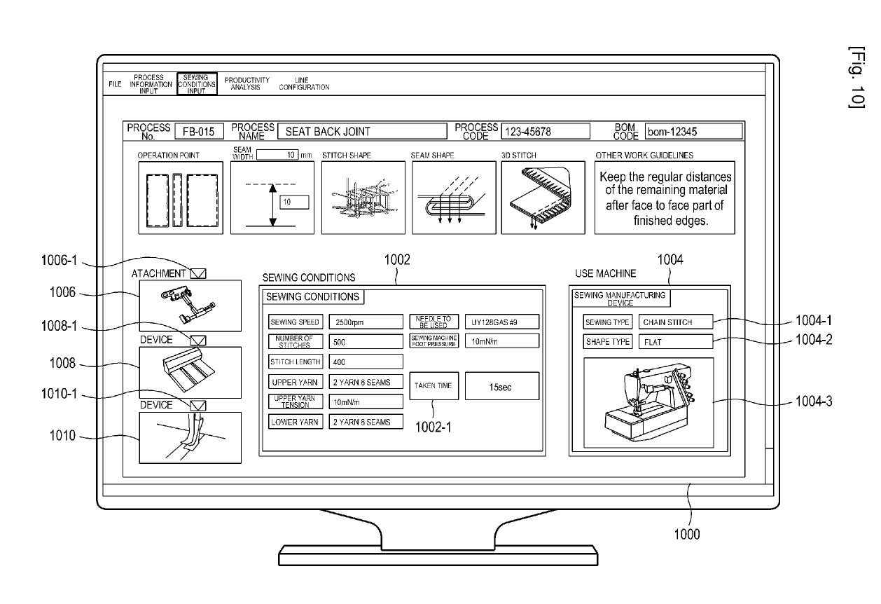

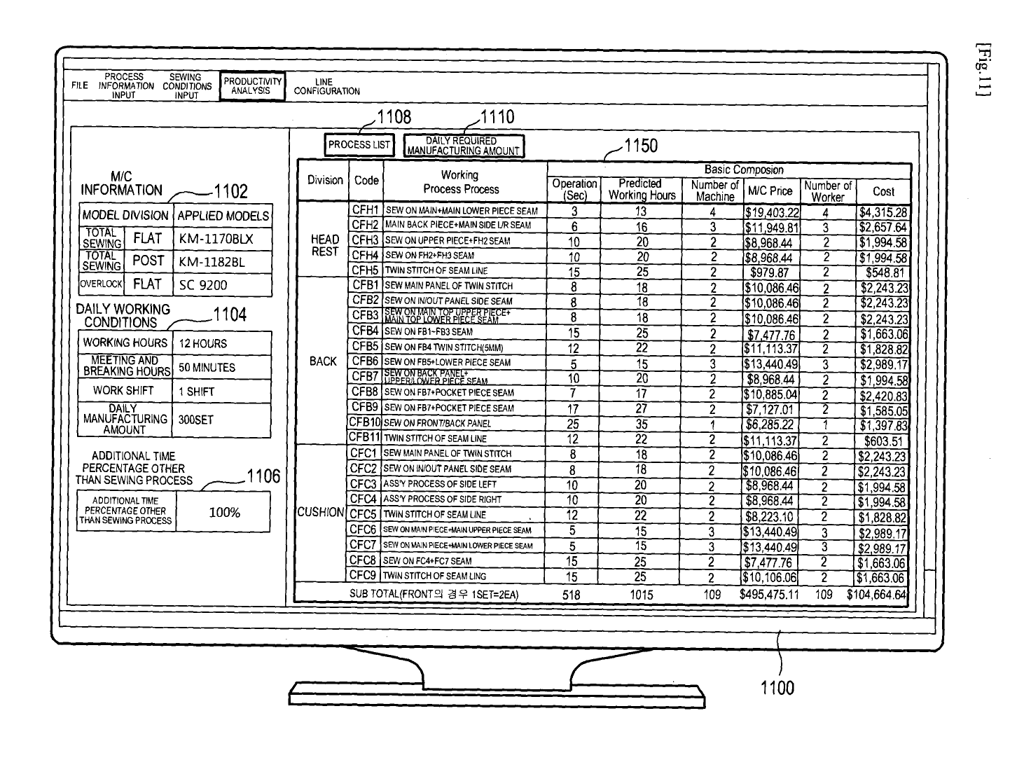

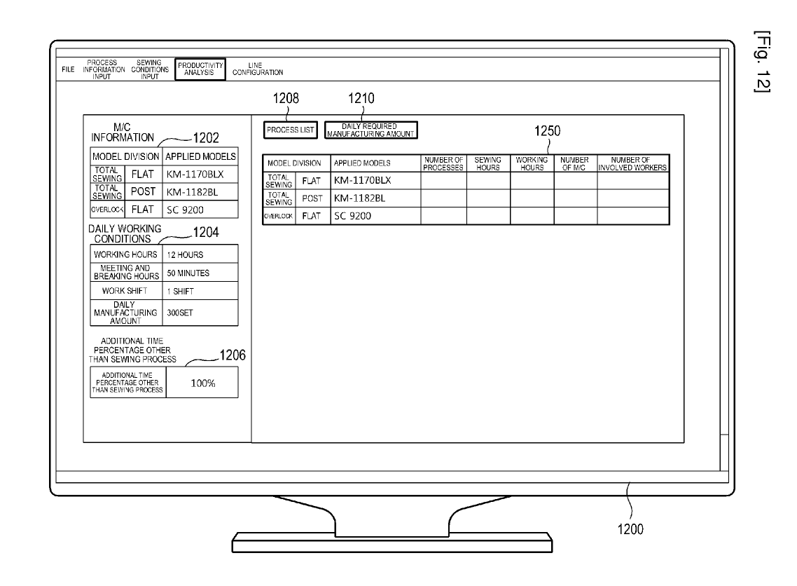

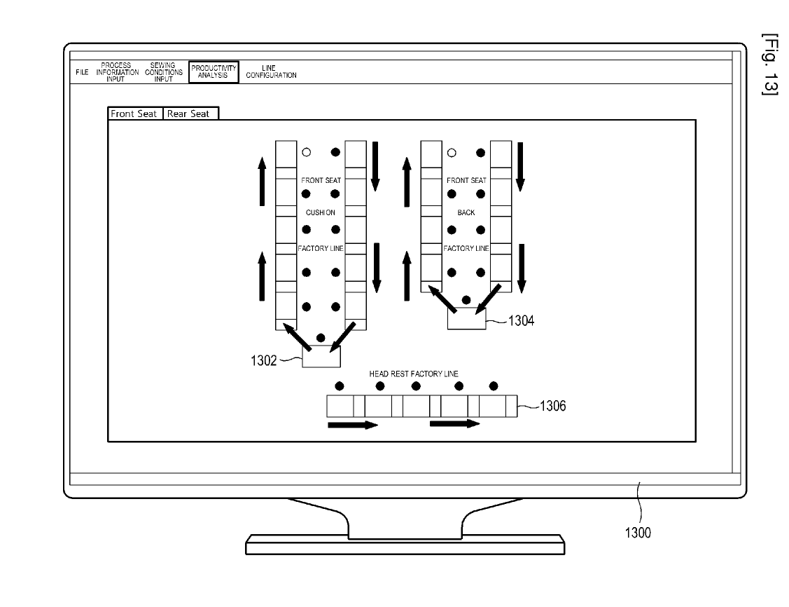

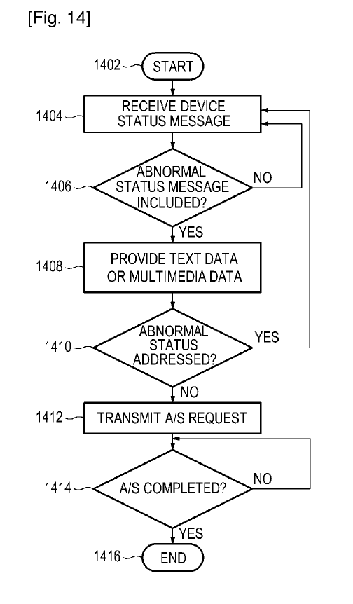

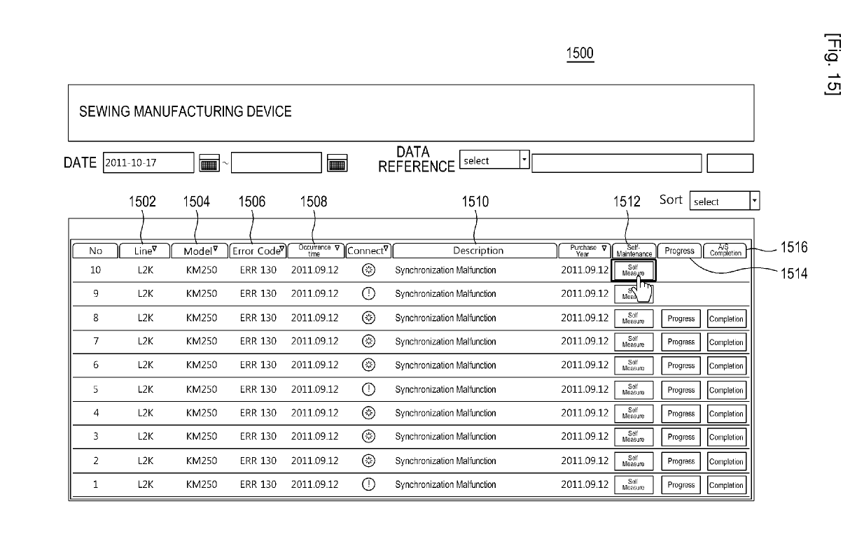

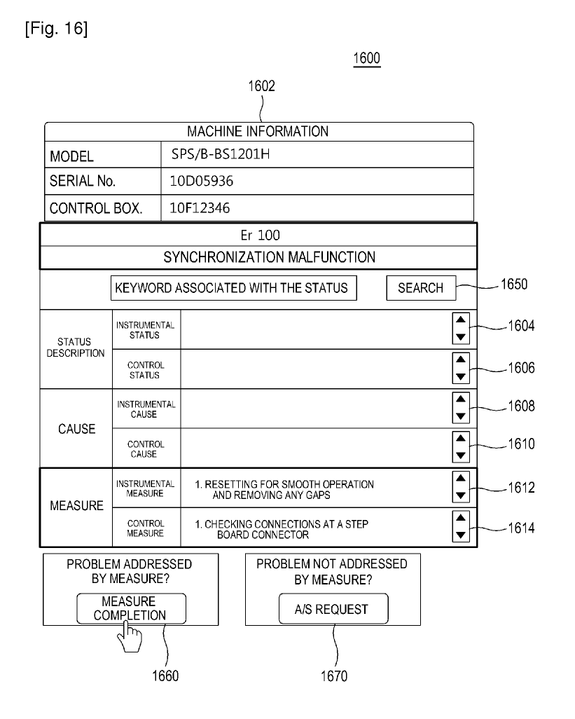

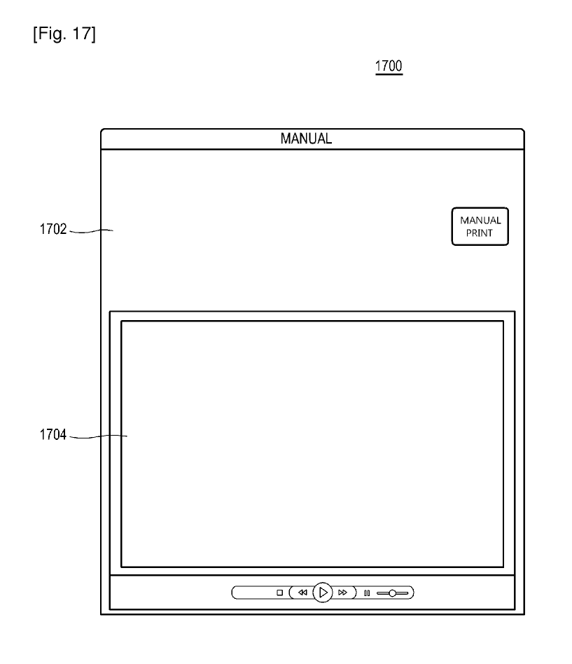

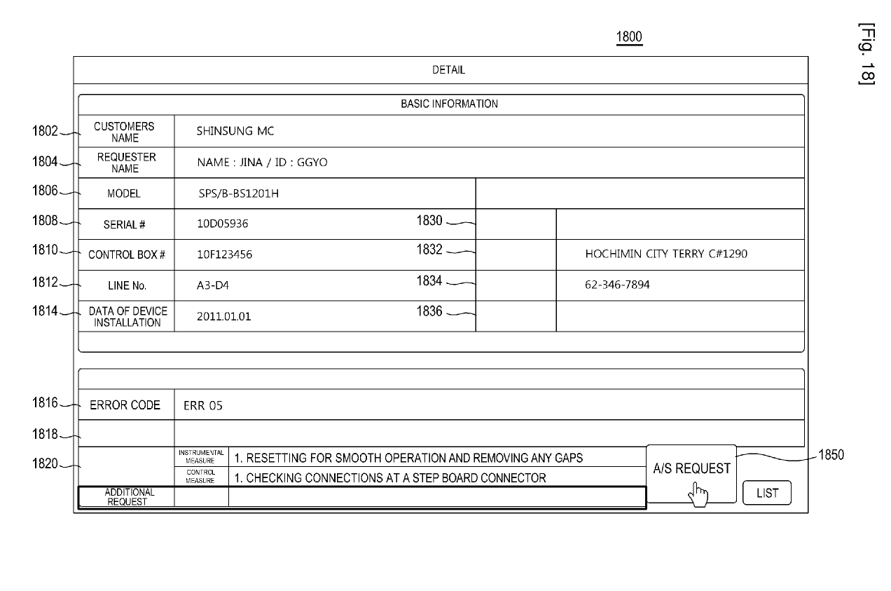

1. A method for sewing design manufacturing management, comprising:
receiving design information on an end product to be manufactured by sewing over a first network;
configuring one or more component shapes of the end product based on the design information;
identifying one or more processes necessary for manufacturing the end product based on analysis of the one or more component shapes;
enabling a user to select one process from the one or more processes; and
enabling the user to input sewing information in association with the selected process.

2. A method for sewing design manufacturing management, comprising:
generating design information on an end product to be manufactured by sewing;
configuring one or more component shapes of the end product based on the design information;
identifying one or more processes necessary for manufacturing the end product based on analysis of the one or more component shapes;
enabling a user to select one process from the one or more processes; and
enabling the user to input sewing information in association with the selected process.

3. The method of claim 1, wherein the identifying comprises identifying an intermediate shape of the end product resulting from execution of each of the processes and configuring one or more process task charts identifying the respective processes and intermediate shapes.

4. The method of claim 1, further comprising predicting at least one of process time and process cost for the selected process, on the basis of the sewing information.

5. The method of claim 4, wherein the sewing information comprises at least one of a stitch shape, a member to be used, a type and color of yarn, a needle, a stitch length, a total number of stitches, stitch start and end positions, an accessory attachment type, and other guidelines for sewing, in association with each of the processes.

6. The method of claim 4, further comprising enabling the user to input sewing data in association with the selected process and wherein the sewing data comprises at least one of a stitch width, a number of stitches, an upper yarn tension, a sewing speed, a sewing machine foot pressure, and a sewing manufacturing device to be used, in each of the processes.

7. The method of claim 1, further comprising transmitting the sewing information to one or more sewing manufacturing devices over a second network.

8. The method of claim 4, further comprising predicting a manufacturing time for the end product.

9. The method of claim 6, wherein the enabling the user to input sewing information further comprises enabling the user to transmit an inquiry or a request for the sewing manufacturing device to be used to a sewing manufacturing device provider.

10. The method of claim 1, further comprising configuring one or more factory lines for manufacturing the end product, on the basis of the sewing information.

11. The method of claim 10, wherein the configuring one or more factory line further comprises determining at least one of: a position of the one or more factory lines; arrangement of one or more sewing manufacturing devices included in the one or more factory lines; and working flow lines of the factory lines.

12. An apparatus for sewing design manufacturing management, comprising:
a network interface configured to receive design information on an end product to be manufactured by sewing over a first network;
a design shape display module configured to generate one or more component shapes of the end product on the basis of the design information;
a design shape analysis module configured to identify one or more processes necessary for manufacturing the end product based on analysis of the one or more component shapes;
an input/output module configured to enable a user to select one process from the processes; and
a sewing information process module configured to receive sewing information associated with the selected process.

13. An apparatus for sewing design manufacturing management, comprising:
a design layout module configured to generate design information on an end product to be manufactured by sewing;
a design shape display module configured to generate one or more component shapes of the end product on a basis of the design information;
a design shape analysis module configured to identify one or more processes necessary for manufacturing the end product based on analysis of the one or more component shapes;
an input/output module configured to enable a user to select one process from the processes; and
a sewing information process module configured to receive sewing information associated with the selected process.

14. The apparatus of claim 12, further comprising a manufacturing prediction module configured to predict at least one of process time and process cost for the selected process, on the basis of the sewing information.

15. The apparatus of claim 14, wherein the sewing information comprises at least one of a stitch shape, a member to be used, a type and color of yarn, a needle, a stitch length, a total number of stitches, stitch start and end positions, an accessory attachment type, and other guidelines sewing, in association with each of the processes.

16. The apparatus of claim 14, further comprising a sewing data process module configured to receive sewing data associated with the selected process and wherein the sewing data comprises at least one of a stitch width, a number of stitches, an upper yarn tension, a sewing speed, a sewing machine foot pressure, and a sewing manufacturing device to be used, in each of the processes.

17. The apparatus of claim 12, wherein the input/output module is configured to enabling the user to transmitting the sewing information to one or more sewing manufacturing devices over a second network.

18. The apparatus of claim 17, wherein the manufacturing prediction module is configured to predict a manufacturing time for the end product.

19. The apparatus of claim 12, wherein the input/output module is configured to enable the user to configure one or more factory lines for manufacturing the end product, on the basis of the sewing information.

20. The apparatus of claim 19, wherein the input/output module is configured to enable the user to determine at least one of: position of the one or more factory lines; arrangement of one or more sewing manufacturing devices included in the one or more factory lines; and working flow lines of the factory lines.

21. The method of claim 7, further comprising receiving a device status message from the one or more sewing manufacturing devices, wherein the device status message includes an abnormal status message indicating the one or more sewing manufacturing devices are in an abnormal status.

22. The method of claim 21, further comprising providing at least one of text data and multimedia data necessary to address the abnormal status on the basis of the abnormal status message.

23. The method of claim 22, further comprising transmitting an A/S request message to a sewing manufacturing device provider on the basis of the abnormal status message.

24. The method of claim 23, further comprising monitoring a status of providing A/S in response to the A/S request message.

25. The apparatus of claim 17, further comprising an A/S module configured to receive a device status message from the one or more sewing manufacturing devices, wherein the device status message includes an abnormal status message indicating the one or more sewing manufacturing devices are in an abnormal status.

26. The apparatus of claim 25, wherein the A/S module is configured to provide text data or multimedia data necessary to address the abnormal status on the basis of the abnormal status message.

27. The apparatus of claim 26, wherein the A/S module is configured to transmit an A/S request message to a sewing manufacturing device provider on the basis of the abnormal status message.

28. The apparatus of claim 27, wherein the A/S module is configured to monitor a status of providing A/S in response to the A/S request message.

29. A sewing manufacturing device connected to a network, the sewing manufacturing device comprising:
a controller configured to receive sewing information in association with a sewing process; and
a display device configured to display text data and multimedia data including information in association with the sewing process,
wherein the controller is configured to provide a device status message over the network, wherein the text data and the multimedia data are provided on the basis of the device status message.

30. The method of claim 2, wherein the identifying comprises identifying an intermediate shape of the end product resulting from execution of each of the processes and configuring one or more process task charts identifying the respective processes and intermediate shapes.

31. The method of claim 2, further comprising predicting at least one of process time and process cost for the selected process, on the basis of the sewing information.

32. The method of claim 31, wherein the sewing information comprises at least one of a stitch shape, a member to be used, a type and color of yarn, a needle, a stitch length, a total number of stitches, stitch start and end positions, an accessory attachment type, and other guidelines for sewing, in association with each of the processes.

33. The method of claim 31, further comprising enabling the user to input sewing data in association with the selected process and wherein the sewing data comprises at least one of a stitch width, a number of stitches, an upper yarn tension, a sewing speed, a sewing machine foot pressure, and a sewing manufacturing device to be used, in each of the processes.

34. The method of claim 2, further comprising transmitting the sewing information to one or more sewing manufacturing devices over a second network.

35. The method of claim 31, further comprising predicting a manufacturing time for the end product.

36. The method of claim 33, wherein the enabling the user to input sewing information further comprises enabling the user to transmit an inquiry or a request for the sewing manufacturing device to be used to a sewing manufacturing device provider.

37. The method of claim 2, further comprising configuring one or more factory lines for manufacturing the end product, on the basis of the sewing information.

38. The method of claim 37, wherein the configuring one or more factory line further comprises determining at least one of: a position of the one or more factory lines; arrangement of one or more sewing manufacturing devices included in the one or more factory lines; and working flow lines of the factory lines.

39. The apparatus of claim 13, further comprising a manufacturing prediction module configured to predict at least one of process time and process cost for the selected process, on the basis of the sewing information.

40. The apparatus of claim 39, wherein the sewing information comprises at least one of a stitch shape, a member to be used, a type and color of yarn, a needle, a stitch length, a total number of stitches, stitch start and end positions, an accessory attachment type, and other guidelines sewing, in association with each of the processes.

41. The apparatus of claim 39, further comprising a sewing data process module configured to receive sewing data associated with the selected process and wherein the sewing data comprises at least one of a stitch width, a number of stitches, an upper yarn tension, a sewing speed, a sewing machine foot pressure, and a sewing manufacturing device to be used, in each of the processes.

42. The apparatus of claim 13, wherein the input/output module is configured to enabling the user to transmitting the sewing information to one or more sewing manufacturing devices over a second network.

43. The apparatus of claim 42, wherein the manufacturing prediction module is configured to predict a manufacturing time for the end product.

44. The apparatus of claims 13, wherein the input/output module is configured to enable the user to configure one or more factory lines for manufacturing the end product, on the basis of the sewing information.

45. The apparatus of claim 44, wherein the input/output module is configured to enable the user to determine at least one of: position of the one or more factory lines; arrangement of one or more sewing manufacturing devices included in the one or more factory lines; and working flow lines of the factory lines.

46. The method of claim 34, further comprising receiving a device status message from the one or more sewing manufacturing devices, wherein the device status message includes an abnormal status message indicating the one or more sewing manufacturing devices are in an abnormal status.

47. The method of claim 46, further comprising providing at least one of text data and multimedia data necessary to address the abnormal status on the basis of the abnormal status message.

48. The method of claim 47, further comprising transmitting an A/S request message to a sewing manufacturing device provider on the basis of the abnormal status message.

49. The method of claim 48, further comprising monitoring a status of providing A/S in response to the A/S request message.

50. The apparatus of claim 42, further comprising an A/S module configured to receive a device status message from the one or more sewing manufacturing devices, wherein the device status message includes an abnormal status message indicating the one or more sewing manufacturing devices are in an abnormal status.

51. The apparatus of claim 50, wherein the A/S module is configured to provide text data or multimedia data necessary to address the abnormal status on the basis of the abnormal status message.

52. The apparatus of claim 51, wherein the A/S module is configured to transmit an A/S request message to a sewing manufacturing device provider on the basis of the abnormal status message.

53. The apparatus of claim 52, wherein the A/S module is configured to monitor a status of providing A/S in response to the A/S request message.
